(19) United States
(12) Patent Application Publication
(10) Pub. No.: US 2011/0260987 A1
(43) Pub. Date: Oct. 27, 2011

(54) DUAL SCREEN ELECTRONIC DEVICE

(75) Inventors: Xin Zhao, Shenzhen City (CN); Xiao-Guang Li, Shenzhen City (CN); Ping Yu, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 12/916,598

(22) Filed: Oct. 31, 2010

(30) Foreign Application Priority Data
Apr. 23, 2010 (CN) 201010154547.9

(51) Int. Cl. G06F 3/041; G09G 3/36

(52) U.S. Cl. 345/173; 345/87

(57) ABSTRACT

A dual screen electronic device includes an E-paper display screen, an LCD screen, a command input unit, a touch input unit, and a processing unit. The E-paper display screen and the LCD screen are arranged on the same side of the electronic device. The command input unit corresponds to the E-paper display screen and produces a trigger signal to trigger the LCD screen. The touch input unit corresponds to the LCD screen and produces touch information in response to user operations. The processing unit receives the trigger signal and the touch information, and executes a function associated with the received trigger signal and touch information. If no touch information produced on the touch input unit over a predefined time, the processing unit drives the LCD screen to enter a rest mode; if a trigger signal is produced, the processing unit then wakes up the LCD screen.

### BACKGROUND

1. Technical Field

The present disclosure relates to electronic devices and, particularly, to a dual screen electronic device.

2. Description of Related Art

Typical dual screen electronic devices, such as dual screen E-book readers, usually include an electronic paper (E-paper) display screen and an LCD screen with a touch screen function. However, the separation of the LCD screen and the E-paper display screen does not satisfy the operation habit of the user. Further, the LCD screen is always in a working state, which would increase the power consumption.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a dual screen electronic device according to an exemplary embodiment.

FIG. 2 is a block diagram of a hardware infrastructure of the dual screen electronic device of FIG. 1.

FIG. 3 is a block diagram of main function modules of a processing unit of the dual screen electronic device of FIG. 2.

### DETAILED DESCRIPTION

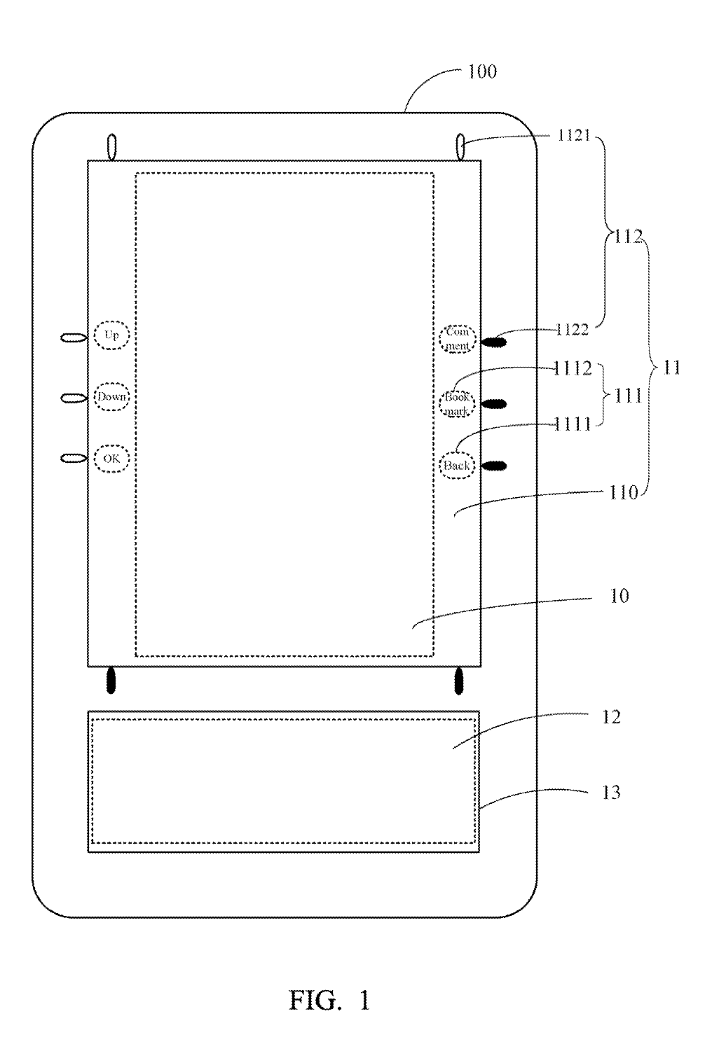

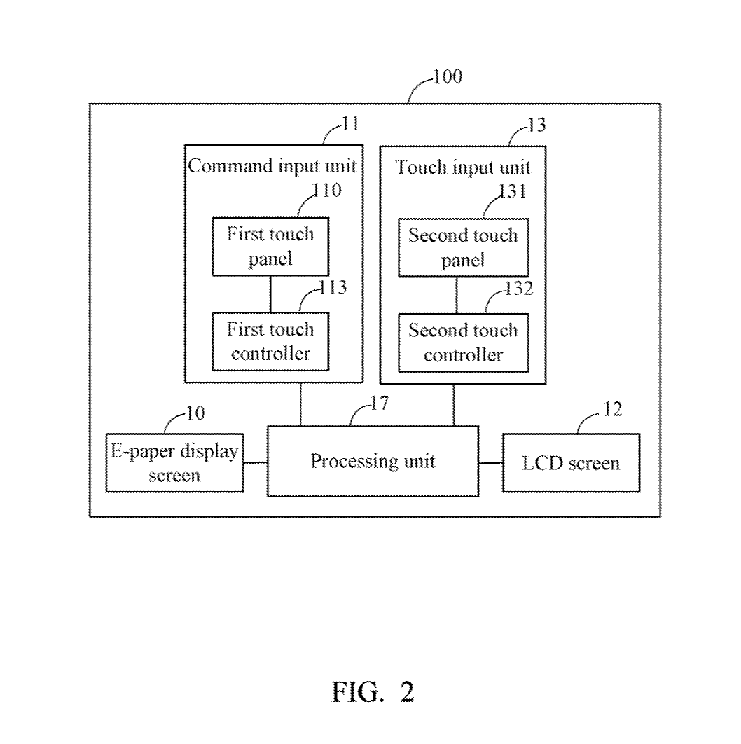

Referring to FIGS. 1 and 2, a dual screen electronic device 100 is disclosed, according to an embodiment. In one embodiment, the dual screen electronic device can be an E-book reader, for instance. The dual screen electronic device 100 includes an E-paper display screen 10, a command input unit 11 corresponding to the E-paper display screen 10, an LCD screen 12, a touch input unit 13 corresponding to the LCD screen 12, and a processing unit 17. In the embodiment, the E-paper display screen 10 and the LCD screen 12 are arranged on the same side of the dual screen electronic device 100, further, the E-paper display screen 10 is aligned with the LCD screen 12. However, it should be noted that the E-paper display screen 10 and the LCD screen 12 can be disposed on different sides of the dual screen electronic device 100 if needed.

The command input unit 11 includes a first touch panel 110 located on the E-paper display screen 10 and a plurality of icons 111. In the embodiment, the command input unit 11 is disabled when the dual screen electronic device 100 is in a non-read mode. The icons 111 can be printed on the first touch panel 110 or displayed on the E-paper display screen 10 when the dual screen electronic device 100 is in a read mode. In the embodiment, the icons 111 include a plurality of control icons 1111 and a plurality of triggering icons 1112. The control icons 1111, which can be predefined for “Up”, “Down”, “OK”, “Back”, are configured for producing a control signal to control the display interface of the E-paper display screen 10. The triggering icons 1112, which can be predefined for “Comment”, “Bookmark”, are configured for producing a trigger signal to trigger the LCD screen 12.

The touch sensitive technology applied on the first touch panel 110 can be resistive, capacitive, infrared, surface acoustic wave, electromagnetic, or near field imaging. In the embodiment, the first touch panel 110 is an infrared touch panel. A plurality of infrared components 112 corresponding to the icons 111 are arranged at the edge of the first touch panel 110. The infrared components 112 include a plurality of infrared emitters 1121 and a plurality of infrared receivers 1122. Each infrared emitter 1121 is corresponding to an infrared receiver 1122.

The command input unit 11 further includes a first touch controller 113 connected to the first touch panel 110. The first touch controller 113 drives the infrared components 112 to work, and determines the location of the touched point by scanning the sensing signals of the infrared components 112.

The touch input unit 13 includes a second touch panel 131 and a second touch controller 132 connected to the second touch panel 131. In the embodiment, the second touch panel 131 is a transparent touch panel and is located on the LCD screen 12 and combines with the LCD screen 12 to form a touch screen. The touch sensitive technology applied on the second touch panel 131 can be resistive, capacitive, infrared, surface acoustic wave, electromagnetic, or near field imaging.

The first touch panel 110 and the second touch panel 131 are configured to produce first and second touch signals in response to user operations. The first touch controller 113 is configured to detect and receive the first touch signals from the first touch panel 110 and determine the touch position according to the first touch signals. The second touch controller 132 is also configured to detect and receive the second touch signals from the second touch panel 131 and determine the touch information including a touch position and a touch path according to the second touch signals.

The processing unit 17 is connected to the first touch controller 113 and the second touch controller 132, and is configured to receive the touch information determined by the first touch controller 113 and the second touch controller 132 and execute a function associated with the received touch information.

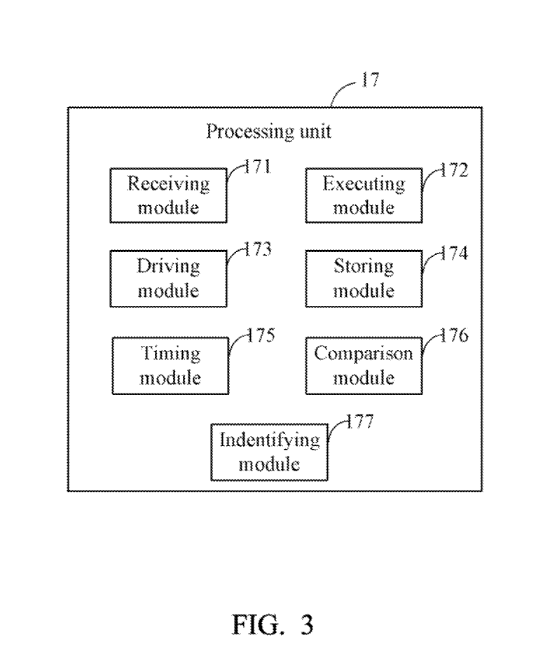

Referring also to FIG. 3, in the embodiment, the processing unit 17 includes a receiving module 171, an executing module 172, a driving module 173, a storing module 174, a timing module 175, a comparison module 176, and an indentifying module 177. The receiving module 171 is configured to receive the touch information from the first touch controller 113 and/or the second touch controller 132. The executing module 172 executes a function associated with the touch information accordingly. The driving module 173 drives the E-paper display screen 10 and the LCD screen 12 to display an interface associated with the function.

When the dual screen electronic device 100 is in a read mode, if the user touches the control icons 1111 on the first touch panel 110, such as “Down”, the receiving module 171 receives and sends the touch information to the executing module 172. The executing module 172 executes the function that scrolls down the current page, at the same time, the driving module 173 drives the E-paper display screen 10 to display an interface associated with the function.

In the embodiment, the storing module 174 stores a word stock (not shown). If the user touches the triggering icons 1112 on the first touch panel 110, such as “Comment”, and then operates on the second panel 131, such as writes on the second panel 131. The indentifying module 177 identifies words of the word stock according to the writing path from the second touch panel 131. The driving module 173 drives the LCD screen 12 to display the writing path, and drives the E-paper display screen 10 to display the identified words.

The driving module 173 is also configured to set the work mode of the command input unit 11 and the LCD screen 12 according to the touch information received by the receiving module 171. When the user enters the read mode after selecting a target file from the second touch panel 131, the driving module 173 starts up the detecting and receiving function of the command input unit 11. Namely, the command input unit 11 is enabled, the timing module 175 records a time that a user stops touching the second touch panel 131 to the time the user touches the second touch panel 131 again, and then the timing module 175 sends the recorded time to the comparing module 176.

The storing module 174 also stores a predefined time pre-set by the user. The comparing module 176 compares the recorded time recorded by the timing module 175 with the predefined time stored in the storing module 174, to decide whether to drive the LCD screen 12 to enter a rest mode. If the recorded time is greater than the predefined time, namely, the second touch controller 132 detects that no second touch signal is produced on the second touch panel 131 over the predefined time, and then the driving module 173 drives the LCD screen 12 to enter a rest mode.

When the LCD screen 12 is in the rest mode, if the user touches the triggering icon 1112 on the first touch panel 110, the receiving module 171 receives a trigger signal produced by the triggering icon 1112, and the driving module 173 then wakes up the

LCD screen 12. If the user touches the second touch panel 131 directly, the executing module 172 gives a hint to the user whether to record words according to the touch signal produced on the second touch panel 131, the executing module 172 then drives the E-paper display screen 10 to pop-up a tip, such as “Current mode is a read mode, record? (Y/N)”. If the user chooses “Y”, then the LCD screen 12 is woke up, and displays the touch information input by the user.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A dual screen electronic device comprising:
an E-paper display screen and an LCD screen arranged on the same side of the electronic device;
a command input unit corresponding to the E-paper display screen, the command input unit comprising a plurality of triggering icons configured for producing a trigger signal to trigger the LCD screen;
a touch input unit corresponding to the LCD screen and configured to produce touch information in response to user operations; and
a processing unit configured to receive the trigger signal and the touch information, and execute a function associated with the received trigger signal and touch information;
wherein, if no touch information produced on the touch input unit over a predefined time, the processing unit drives the LCD screen to enter a rest mode;
when the LCD screen is in the rest mode, if a trigger signal is produced, the processing unit then wakes up the LCD screen.

2. The dual screen electronic device of claim 1, wherein the E-paper display screen is aligned with the LCD screen.

3. The dual screen electronic device of claim 1, wherein the command input unit further comprises a first touch panel located on the E-paper display screen and configured to produce first touch signals in response to user operations.

4. The dual screen electronic device of claim 3, wherein the command input unit further comprises a plurality of control icons configured for producing a control signal to control the display interface of the E-paper display screen.

5. The dual screen electronic device of claim 4, wherein the control icons and the triggering icons can be printed on the first touch panel or displayed on the E-paper display screen.

6. The dual screen electronic device of claim 4, wherein the command input unit further comprises a first touch controller connected to the first touch panel, the first touch controller is configured to detect and receive the first touch signals from the first touch panel and determine the touch position according to the first touch signals.

7. The dual screen electronic device of claim 6, wherein the touch input unit comprises a second touch panel located on the LCD screen and configured to produce second touch signals in response to user operations.

8. The dual screen electronic device of claim 7, wherein the touch input unit further comprises a second touch controller connected to the second touch panel, the second touch controller is configured to detect and receive the second touch signals from the second touch panel and determine the touch information comprising a touch position and a touch path according to the second touch signals.

9. The dual screen electronic device of claim 8, wherein the processing unit comprises:
a receiving module configured to receive the touch information from the first touch controller and/or the second touch controller;
an executing module executing a function associated with the touch information accordingly;
a driving module configured to drive the E-paper display screen and the LCD screen to display an interface associated with the function, and set the work mode of the command input unit and the LCD screen according to the touch information;
a storing module storing a predefined time;
a timing module recording a time that a user stops touching the second touch panel to the time the user touches the second touch panel again;
a comparison module comparing the recorded time recorded by the timing module with the predefined time stored in the storing module to decide whether to drive the LCD screen to enter a rest mode.

10. The dual screen electronic device of claim 1, wherein the command input unit is disabled when the dual screen electronic device is in a non-read mode.
